(19) United States
(12) Patent Application Publication
(10) Pub. No.: US 2026/0303823 A1
(43) Pub. Date: Oct. 1, 2026

(54) MULTILAYER VIDEO CODING WITH CONSTRAINED COMPLEXITY

(71) Applicant: InterDigital CE Patent Holdings, SAS, Paris (FR)

(72) Inventors: Fabrice URBAN, Thorigne Fouillard (FR); Gwenaelle MARQUANT, la chapelle chaussee (FR); Philippe DE LAGRANGE, Betton (FR); Charles SALMON-LEGAGNEUR, Rennes (FR)

(21) Appl. No.: 19/483,496

(22) PCT Filed: May 13, 2024
(86) PCT No.: PCT/EP2024/063083

§ 371 Date: Nov. 11, 2025

(30) Foreign Application Priority Data
May 16, 2023 (EP) 23305785.0

(51) Int. Cl. H04N 19/14; H04N 19/169

(52) U.S. Cl. CPC H04N 19/14; H04N 19/1883

(57) ABSTRACT

Apparatuses and methods are disclosed including techniques for encoding video data. The disclosed techniques include obtaining video data, including a multilayer video. These techniques further include determining coding configurations that are adapted to respective layers of the multilayer video, and coding into a bitstream the layers based on their respective coding configurations. Additionally, apparatuses and methods are disclosed including techniques for decoding video data. The disclosed techniques include obtaining a bitstream that codes video data including a multilayer video. These techniques further include decoding from the bitstream coding configurations, that are determined to adapt to respective layers of the multilayer video, and decoding from the bitstream the layers based on their respective coding configurations.

### CROSS REFERENCE TO RELATED APPLICATIONS

This application claims the benefit of European Application No. 23305785.0, filed on May 16, 2023, which is incorporated herein by reference in its entirety.

### BACKGROUND

Coding standards, such as VVC, define coding configurations by means of profiles, tiers, and levels. These coding configurations impose operational constraints that limit the coding toolsets and the ranges of coding parameters that an encoder can utilize for the compression of a video. The profile (and associated level and tier) according to which a coded video bitstream is generated by the encoder is signaled to a decoder, for the latter to verify whether computational resources can be allocated for the decoding of that bitstream. Similarly, a multilayer video can be encoded according to a multilayer profile. A decoder conforming to the multilayer profile needs to have the processing power to decode the multilayer video. In principle, for each layer, the full toolset available in the encoder may be used, and so the processing power required of a multilayer decoder may be the sum of the processing power required to decode each layer. However, in practice and based on specific application requirements, a different toolset can be applied to the encoding of each layer to control the processing power required for the decoding of each layer, while maintaining acceptable compression performance.

### SUMMARY

Aspects disclosed in the present disclosure describe methods for encoding video data. The methods include obtaining video data, including a multilayer video. The methods further include determining coding configurations that are adapted to respective layers of the multilayer video and coding into a bitstream the layers based on their respective coding configurations. Aspects disclosed in the present disclosure also describe methods for decoding video data. The methods include obtaining a bitstream that codes video data including a multilayer video. The methods further include decoding from the bitstream coding configurations (determined to adapt to respective layers of the multilayer video) and decoding from the bitstream the layers based on their respective coding configurations.

Aspects disclosed in the present disclosure describe apparatuses for encoding video data. The apparatuses comprise at least one processor and memory storing instructions. The instructions, when executed by the at least one processor, cause the apparatuses to obtain video data, including a multilayer video. The instructions further cause the apparatuses to determine coding configurations that are adapted to respective layers of the multilayer video and coding into a bitstream the layers based on their respective coding configurations. Aspects disclosed in the present disclosure also describe apparatuses for decoding video data. The apparatuses comprise at least one processor and memory storing instructions. The instructions, when executed by the at least one processor, cause the apparatuses to obtain a bitstream that codes video data including a multilayer video. The instructions further cause the apparatuses to decode from the bitstream coding configurations (determined to adapt to respective layers of the multilayer video) and to decode from the bitstream the layers based on their respective coding configurations.

Further aspects disclosed in the present disclosure describe a non-transitory computer-readable medium comprising instructions executable by at least one processor to perform methods for encoding video data. The methods include obtaining video data, including a multilayer video. The methods further include determining coding configurations that are adapted to respective layers of the multilayer video and coding into a bitstream the layers based on their respective coding configurations. Aspects disclosed in the present disclosure also describe a non-transitory computer-readable medium comprising instructions executable by at least one processor to perform methods for decoding video data. The methods include obtaining a bitstream that codes video data including a multilayer video. The methods further include decoding from the bitstream coding configurations (determined to adapt to respective layers of the multilayer video) and decoding from the bitstream the layers based on their respective coding configurations.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to which aspects of the present embodiments can be implemented.

FIG. 2 is a functional block diagram of an example video encoder, according to which aspects of the present embodiments can be implemented.

FIG. 3 is a functional block diagram of an example video decoder, according to which aspects of the present embodiments can be implemented.

FIG. 4 is a diagram illustrating a CU decoding pipeline, according to which aspects of the present embodiments can be implemented.

FIG. 5 is a diagram illustrating a multilayer encoding/decoding workflow, according to which aspects of the present embodiments can be implemented.

FIG. 6 is a diagram illustrating a reduced CU decoding pipeline, according to which aspects of the present embodiments can be implemented.

FIG. 7 is a diagram illustrating a further reduced CU decoding pipeline, according to which aspects of the present embodiments can be implemented.

FIG. 8 is a diagram illustrating an inter-layer picture prediction, according to which aspects of the present embodiments can be implemented.

FIG. 9 is a flowchart of an example method for encoding a multilayer video, according to which aspects of the present embodiments can be implemented.

FIG. 10 is a flowchart of an example method for decoding a multilayer video, according to which aspects of the present embodiments can be implemented.

### DETAILED DESCRIPTION

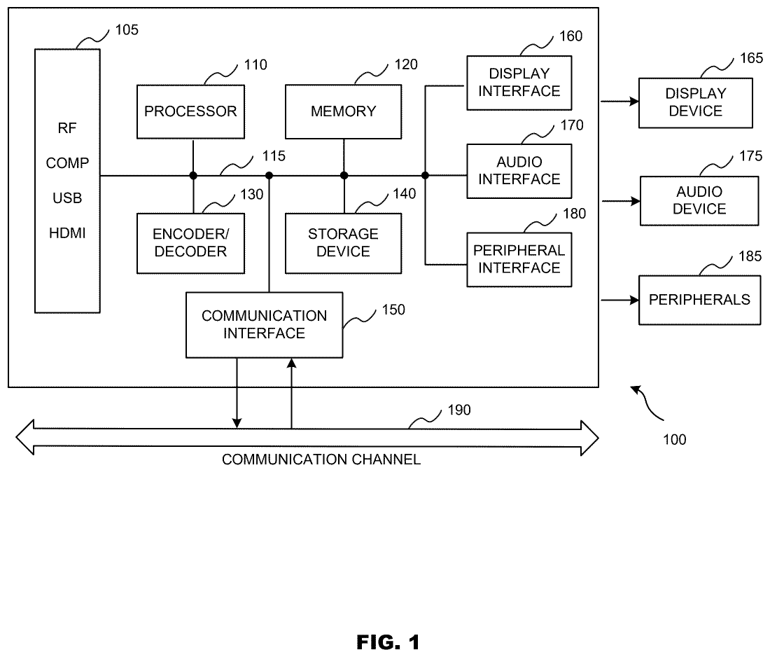

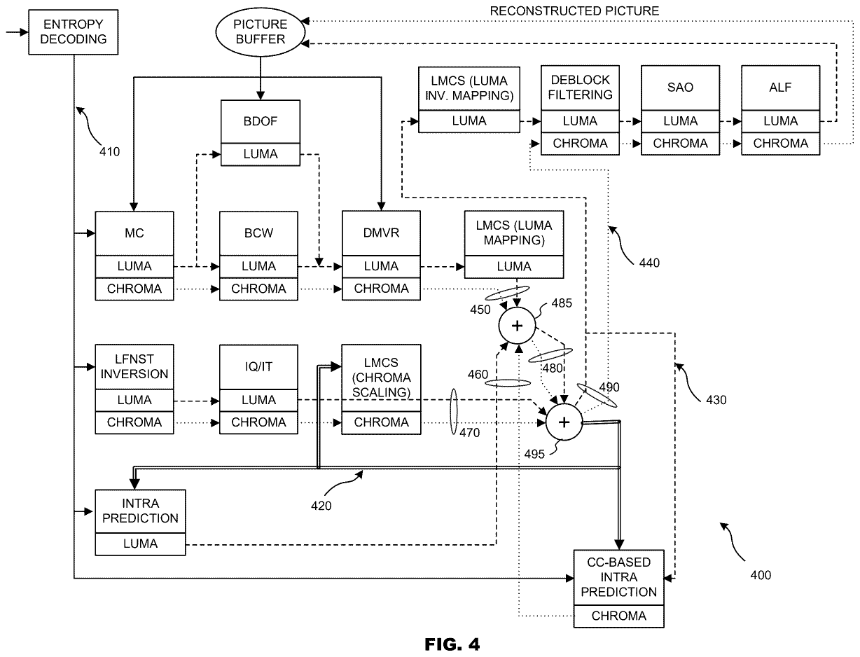

Systems and methods are presented herein for encoding and decoding of a multilayer video. According to aspects, coding configurations are devised that are adapted to each layer of the multilayer video. The proposed adaptive coding configurations introduce operational constraints that enable overall reduction in computational complexity and enable parallel processing in the decoder. Traditional systems and methods for predictive video coding are described next in reference to FIGS. 1-3, followed by description of aspects of the present disclosure, described in reference to FIGS. 4-10.

FIG. 1 illustrates a block diagram of an example system 100. System 100 can be embodied as a device and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in an integrated circuit, multiple integrated circuits, and/or discrete components. For example, in at least one embodiment, the processing 110 and encoder/decoder 130 elements of system 100 are distributed across multiple integrated circuits and/or discrete components. In various embodiments, the system 100 is communicatively coupled to other systems, or to other electronic devices, via, for example, a communications bus or through dedicated input and/or output ports.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120, such as a volatile memory device and/or a non-volatile memory device. System 100 includes a storage device 140, which can include non-volatile memory and/or volatile memory, such as EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide encoded video data or decoded video data. The encoder/decoder module 130 can include its own processor and memory. The encoder/decoder module 130 can be implemented as a separate element of system 100 or can be incorporated within processor 110 as a combination of hardware and/or software as known to those skilled in the art. Additionally, the encoder/decoder module 130 represents module(s) that can be implemented in a separate device to perform encoding and/or decoding functions.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, operational logic, and intermediate or final results from the processing of equations, formulas, operations.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data can be streamed to the system 100, in various embodiments, using a Wi-Fi network such as IEEE 802.11. The Wi-Fi signal of these embodiments is received over the communication channel 190 and the communication interface 150 which can be adapted for Wi-Fi communications. The communication channel 190 of these embodiments is typically connected to an access point or router that provides access to outside networks including the Internet for allowing streaming applications and other over-the-top communications. In other embodiments, data can be streamed to the system 100 using a set-top box that delivers the data over the HDMI connection of the input block 105 or data can be streamed to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or the other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

Alternatively, the display device 165 and the audio device 175 can be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

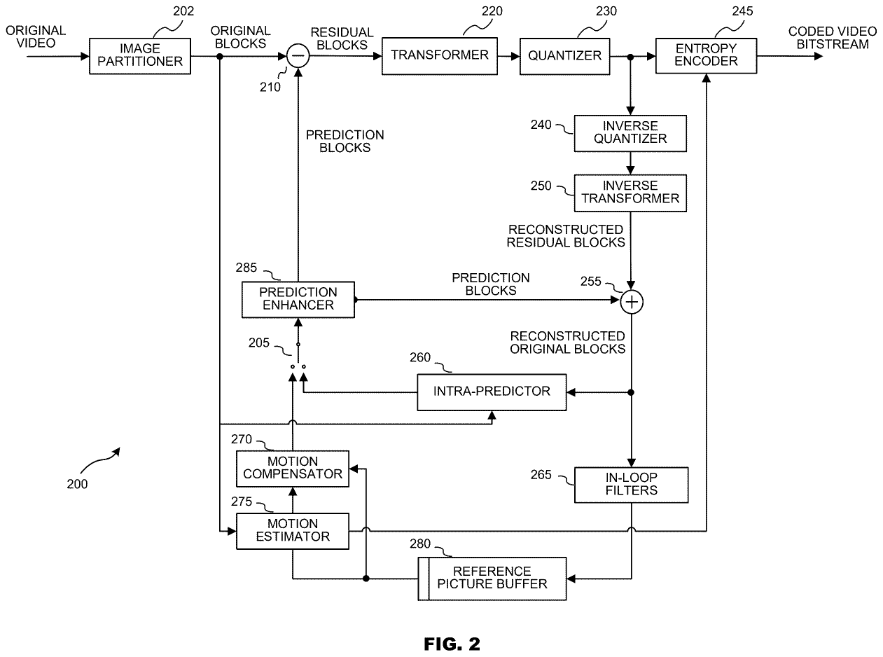

FIG. 2 illustrates a functional block diagram of an example video encoder 200. The video encoder 200 can be employed by the system 100 described in reference to FIG. 1. For example, the video encoder 200 can be an encoder that operates according to coding standards such as Advanced Video Coding (AVC, H.264/MPEG-4|ISO/IEC 14496-10), High Efficiency Video Coding (HEVC, ITU-T H.265|ISO/IEC 23008-2), or Versatile Video Coding (VVC, Standard ITU-T H.266, ISO/IEC 23090-3, 2020).

Prior to undergoing encoding, the video data can be pre-processed by a precoding processor (not shown). Such pre-processing can include applying a color model transform to the color components of the input video frames (e.g., conversion from RGB 4:4:4 to YCbCr 4:2:0) or mapping the color components of the input video frames to obtain a signal distribution that is more resilient to compression (for instance, applying a histogram equalizer and/or a denoising filter to one or more of the video frames' color components). The pre-processing can also include associating metadata with the video data that can be attached to the coded video bitstream.

In the encoder 200, a video frame is encoded by the encoder elements as generally described below. A picture (frame) of the original video to be encoded is partitioned into coding units (namely, original blocks) by an image partitioner 202. Typically, a coding unit (CU) contains a luminance block and respective chroma blocks, and so, generally, operations described herein as applied to a CU are applied to the luminance block and to the respective chroma blocks. Following partition 202, each CU can be encoded using an intra-prediction mode or an inter-prediction mode. In an intra-prediction mode, a prediction of the CU is performed by an intra-predictor 260. In the intra-prediction mode, the content of a CU in a frame is predicted based on content from one or more other CUs of the same frame, using the other CUs' reconstructed version (available from the adder 255 output). In an inter-prediction mode, motion estimation and motion compensation are performed by a motion estimator 275 and a motion compensator 270, respectively. In the inter-prediction mode, the content of a CU in a frame is predicted based on content from one or more other CUs of neighboring frames, using the other CUs' reconstructed versions (available from the reference picture buffer 280). The encoder decides 205 which prediction result (one obtained through operations in the intra-prediction mode 260 or one obtained through operations in the inter-prediction mode 270, 275) to use for encoding a CU, and indicates the selected prediction mode by a prediction mode flag, for example. The selected prediction result may then be enhanced (e.g., filtered) by a prediction enhancer 285, outputting a respective prediction block. Once a prediction block is generated for each CU, a respective residual block is calculated, for example, by subtracting 210 the predicted CU (i.e., prediction block) from the CU (i.e., original block).

A CU's respective residual block or a partition thereof (i.e., a transform block) is then transformed into a coefficient block by a transformer 220—that is, residual samples of the transform block are transformed into transform coefficients of the coefficient block. The resulting coefficient block is quantized by a quantizer 230. An entropy encoder 245 is next employed to entropy-encode the quantized coefficient block and respective coding parameters (e.g., syntax elements including motion vectors and other control data). Hence, the entropy-encoded quantized coefficient blocks and respective encoding parameters associated with each video frame of the original video are packed into the bitstream of the coded video data.

Along with the coding of original blocks (CUs), as described above, the encoder 200 reconstructs the coded original blocks to provide references for future predictions. Accordingly, quantized coefficient blocks (provided by the quantizer 230) are de-quantized, by an inverse quantizer 240, and then inverse transformed, by an inverse transformer 250, to reconstruct (decode) the residual blocks of respective original blocks. Adding 255 the reconstructed residual blocks to respective prediction blocks results in respective reconstructed original blocks. In-loop filters 265 can then be applied to the reconstructed picture (formed by the reconstructed original blocks), performing, for example, deblocking filtering and/or sample adaptive offset (SAO) filtering to reduce encoding artifacts. The filtered reconstructed picture can then be stored in the reference picture buffer 280, available for future predictions in an inter-prediction mode. Thus, the encoder 200 also performs decoding operations 240, 250 through which the encoded pictures (frames) are reconstructed. The reconstructed pictures can then be stored in the reference picture buffer 280 and be used to facilitate motion estimation 275 and compensation 270, as explained above.

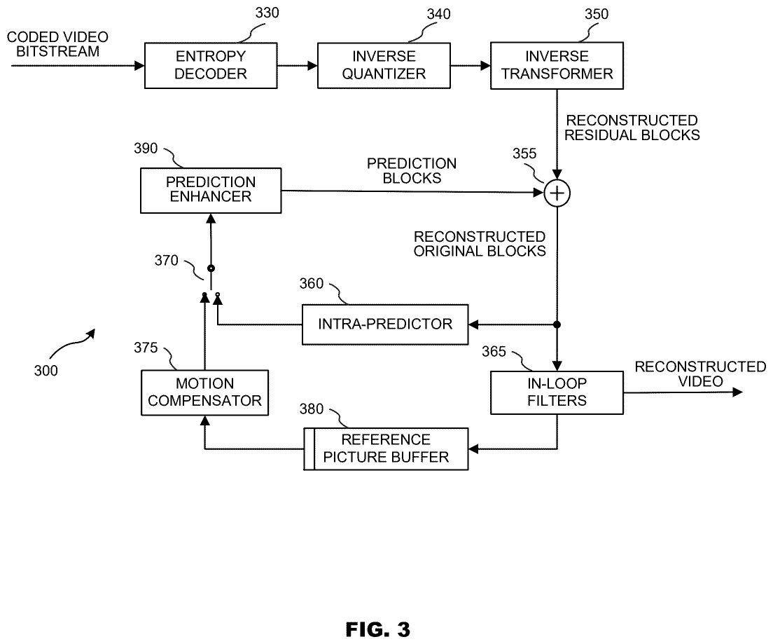

FIG. 3 illustrates a functional block diagram of an example video decoder 300. The video decoder 300 can be employed by the system 100 described in reference to FIG. 1. Generally, operational aspects of the video decoder 300 are reciprocal to operational aspects of the video encoder 200. In the decoder 300, the bitstream of coded video data, generated by the video encoder 200, is first entropy-decoded by an entropy decoder 330, decoding from the bitstream the quantized coefficient blocks and various coding parameters. The quantized coefficient blocks are de-quantized, by an inverse quantizer 340, and then are inverse transformed, by an inverse transformer 350, to decode (reconstruct) respective residual blocks. Adding 355 the reconstructed residual blocks to respective prediction blocks results in respective reconstructed original blocks. Depending on the selected prediction mode, a predicted original block can be obtained 370 from an intra-predictor 360 or from a motion compensator 375 and may then be enhanced (e.g., filtered) by a prediction enhancer 390, generating a prediction block. In-loop filters 365 can be applied to the reconstructed picture (formed by the reconstructed original blocks), outputting a reconstructed (decoded) video frame. The filtered reconstructed picture is also stored in a reference picture buffer 380 to facilitate motion compensation 375.

A post-decoding processor (not shown) can further process the reconstructed video. For example, post-decoding processing can include an inverse color model transform (e.g., conversion from YCbCr 4:2:0 to RGB 4:4:4) or an inverse mapping to reverse the mapping process performed by the pre-encoding processor. The post-decoding processor can use metadata that were derived by the pre-encoding processor and/or were signaled in the video bitstream.

Aspects disclosed herein are described in reference to a CU, however, the described aspects are similarly applicable to any region of the video frame (i.e., video data region) that coding tools may be applied to by an encoder 260 or by a decoder 360. Generally, aspects described herein may be applied to a video data region, formed by a video partition, of any shape or size. A CU includes a luma component, Y, and chroma components, Cr and Cb (either one of which is referred to herein also by C).

FIG. 4 is a diagram illustrating a CU decoding pipeline 400. Coding tools (represented by the building blocks shown in FIG. 4) are employed to decode a current CU (e.g., as described with respect to the decoder of FIG. 3) from a coded video bitstream (e.g., generated as described with respect to the encoder of FIG. 2). Table 1 describes some of the coding tools.

TABLE 1
Decoder coding tools

| Coding Tools | Description |
|---|---|
| Bi-prediction with | Weighted blending of two temporal (inter) |
| CU-level weights | predictions (bi-predictions) of a CU into one |
| (BCW) | prediction (e.g., useful for modeling fading |
| | effects) |
| Bi-directional | Decoder-side motion refinement (with no |
| optical flow | extra signaling) by post-processing of bi- |
| (BDOF) | predictions of a CU using optical flow to |
| | compensate for fine pixel-based motion |
| | missed by the block-based motion |
| | compensation operation. |
| decoder side motion | Decoder-side fine motion refinement (with |
| vector refinement | no extra signaling) to improve motion |
| (DMVR) | vector accuracy, using reference frames for |
| | motion estimation. |
| low frequency non- | A Secondary transform that further |
| separable transform | transforms the transformed residual data |
| (LFNST) | (output of transformer 220) prior to |
| | quantization 230. |
| Luma Mapping with | Performing luma mapping and chroma |
| Chroma Scaling | scaling: |
| (LMCS) | Luma Mapping - the luma component is |
| | remapped after prediction and inverse |
| | remapped after reconstruction (see LMCS |
| | (Luma mapping) and LMCS (Inverse |
| | luma mapping) in FIG. 4) to reduce the |
| | cost of the transforming 220 residual data. |
| | Chroma scaling: the chroma is predicted |
| | from the remapped luma component, and |
| | thus the chroma component is accordingly |
| | scaled (see LMCS (Chroma scaling) in |
| | FIG. 4). |

In the example of FIG. 4, bitstream data associated with the current CU is first entropy decoded to extract therefrom information, including coding parameters and the coded residual of the current CU. The picture buffer stores reconstructed pictures that can be used as reference for inter-prediction. Coding tools—including motion compensation (MC), BCW, BDOF, DMVR, and LMCS (Luma mapping)—perform operations associated with predicting content of the current CU in inter-prediction mode 450. Coding tools—including the intra-prediction and the cross-component (CC) based intra-prediction—perform operations associated with predicting content of the current CU in intra-prediction mode 460. Thus, the predicted CU 480 can be generated by intra-prediction 460 and/or by inter-prediction 450 (see adder 485). Note that a combined intra-inter prediction (CIIP) feature in VVC can be used to create a prediction that is a combination of both intra-prediction and inter-prediction that are blended with associated signaled weights. Coding tools—including the LFNST inversion, inverse quantization and transformation (IQ/IT), and LMCS (Chroma scaling)—perform operations associated with reconstructing the residual of the current CU 470. The residual of the current CU 470 is then added to the predicted current CU 480 (see adder 495), resulting in a reconstructed current CU 490. The reconstructed current CU 490 together with other reconstructed CUs of the current picture are then in-loop filtered to generate the reconstructed picture. Thus, following the application of LMCS (Luma inverse mapping), the in-loop filtering operation can be performed by one or more coding tools, including deblocking filter, SAO, and ALF tools.

In the example of FIG. 4, dependency on data flows that had originated from the entropy decoder and the picture buffer is illustrated with full lines (e.g., 410); dependency on data flows associated with reconstructed neighboring CU(s) is illustrated with double lines (e.g., 420); dependency on data flows associated with the current luma component Y is illustrated with dashed lines (e.g., 430); and dependency on data flows associated with the current chroma component C is illustrated with dotted lines (e.g., 440). Satisfying these dependencies is needed to allow for proper operation of the decoding pipeline. Specifically, satisfying dependencies 410 is needed to decode coding parameters and to inter-predict the current CU by reference to previously decoded pictures from the picture buffer. When decoding a current CU, satisfying dependencies associated with reconstructed CUs in the neighborhood of the current CU 420 is needed to intra-predict the current CU. For example, the CC-based intra-prediction tool depends on reconstructed CU(s) 420 in its neighborhood to derive a model (e.g., CCLM) and on the reconstructed current luma component 430 to perform the prediction. In the enhanced compression model (ECM)—that is, the software used by the joint video expert group (JVET) to study future video coding standards after VVC—satisfying dependencies associated with reconstructed CUs in the neighborhood of the current CU is also needed to apply template matching (TM) modes. TM modes use the reconstructed neighborhood of the current CU to predict coding parameters (such as motion vector, intra-coding direction, or other coding modes) for the current CU.

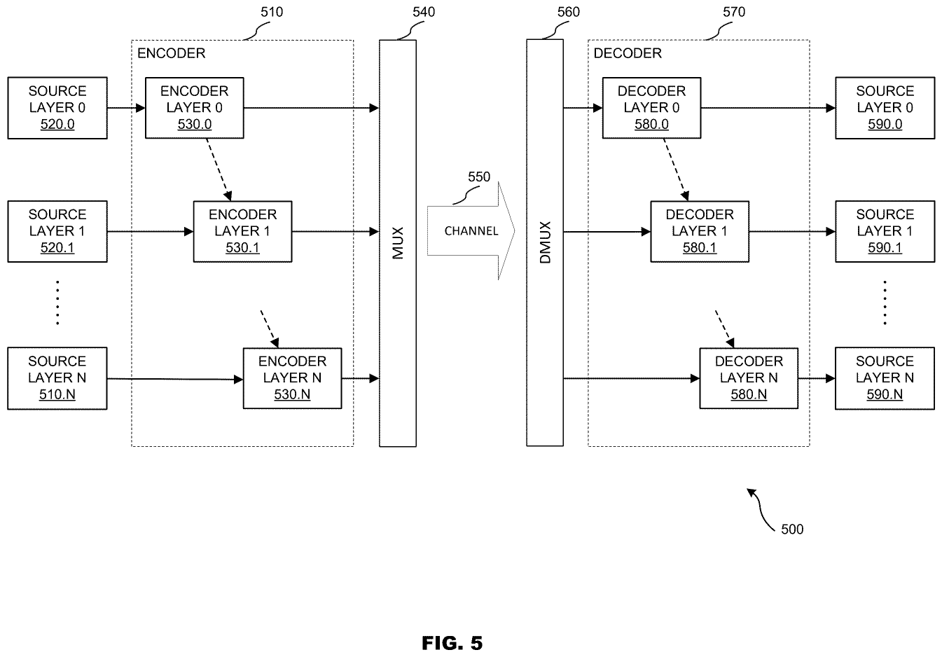

Dependencies in the decoding pipeline also exist in multilayer encoding. VVC enables multilayer encoding with a multilayer profile. Multilayer encoding can be instrumental for use-cases requiring video scalability and/or multiview (or 360°) video representation, for example. In multilayer encoding, layers of a video source are coded separately or with inter-layer dependency, and the resulting respective bitstreams are then merged into a single bitstream delivered to a decoder end for multilayer decoding, as further described with respect to FIG. 5.

FIG. 5 is a diagram illustrating a multilayer encoding/decoding workflow 500. As shown in the example of FIG. 5, an encoder 510 and a decoder 570 are connected through a multiplexer 540, a channel 550 (e.g., a wired or a wireless communication link(s)), and a de-multiplexer 560. In the encoder 510, for each layer, a separate encoder instance can be employed. For example, N layer encoders may be employed, such as encoder layer 0 (530.0), encoder layer 1 (530.1), and encoder layer N (530.N) that encode their respective inputs: source layer 0 (520.0), source layer 1 (520.1), and source layer N (520.N). For example, each source can correspond to a different resolution level of the same input picture—from the lowest resolution level 520.0, through intermediate resolution levels 520.1 to 520.N-1, to the highest resolution level 520.N. Additionally, a source layer (e.g., such as 520.1) can be encoded (e.g., by encoder 530.1) relative to a reference picture provided by the encoder of the level below (e.g., encoder 530.0). This creates an interlayer dependency, due to inter-layer prediction (illustrated by the dashed arrows) in both the encoder 510 and the decoder 570 ends.

Hence, for each frame of a video sequence, layer encoders 530.0-N are launched to encode the pictures of respective layers, where an encoder of a lower layer is employed before an encoder of a higher layer because of the dependency introduced by the inter-layer prediction. For every frame, the output bitstreams (i.e., sub-bitstreams) of respective layer encoders 530.0-N are multiplexed 540 into one bitstream. Coded in that bitstream are also layers' ID information (IDentification number) that associate the sub-bitstreams with their respective layer. The layers' ID information can be signaled at the Network Abstraction Layer Unit (NALU) header for example (NALU is a syntax structure containing an indication of the type of data that follow, and bytes containing that data in the form of a raw byte sequence payload interspersed as necessary with emulation prevention bytes). The layer encoders 530.0-N share layer-independent data structures such as APS (Adaptive Parameter Sets) and VPS (Video Parameter Sets) that can also be coded into the bitstream.

The bitstream generated by the encoder 510 is delivered through the channel 550 to the decoder 570 for layered decoding. The channeled bitstream is first de-multiplexed 560 into the layers' respective sub-bitstreams. Thus, the sub-bitstream of layer 0 can be decoded by decoder layer 0 (580.0) independently to generate a reconstructed source layer 0 (590.0), the sub-bitstream of layer 1 can be decoded by decoder layer 1 (580.1) with dependency on output from decoder layer 0 (580.0) (receiving therefrom a reference picture) to generate a reconstructed source layer 1 (590.1), and the sub-bitstream of layer N can be decoded by decoder layer N (580.N) with dependency on output from decoder layer N−1 (receiving therefrom a reference picture) to generate a reconstructed source layer N (590.N). Accordingly, for each frame, decoding a multilayer bitstream requires first decoding layers from a lower level before decoding layers from a higher level. In the example of FIG. 5, layer 0 is first decoded 580.0, then layer 1 can be decoded 580.1, and, finally, layer N can be decoded 580.N. Note that each layer decoder 580.0-N requires full decoding capabilities, including entropy decoding, inverse-quantizing, inverse-transforming, predicting, and in-loop filtering functionalities. This can lead to a processing of high complexity at the decoder end, proportional to the number of layers that have to be decoded for each frame.

The VVC standard defines an output layer set (OLS) as the set of layers for which one or more layers are specified as the output layers. Thus, a given layer needs to be decoded only if it is defined as an output layer or if it is needed as a dependent layer of an output layer. OLSs are typically defined in the VPS. An OLS is signaled by indicating the output layers of the respective OLS. Other layers that belong to that OLS are derived by the layer dependencies indicated in the VPS. OLS is used to (i) signal which layers can be output (together if several layers are indicated as output layers in the same OLS) and which layers will be decoded, and (ii) associate to each VPS some properties, such as a PTL for each OLS. In practice, for spatially scalable video, the first OLS contains only the base layer that is output, the second OLS contains the second layer as output, and the base layer as dependency, the third OLS contains the third layer as output, and the second and base layers as dependencies (second layer being a direct dependency of third layer, base layer an indirect dependency, needed to decode the second layer). For each OLS, complexity constraints can be different as indicated by its associated PTL.

Considering the practicality of implementing the full syntax defined by the VVC standard, a limited number of subsets of the syntax are defined in VVC by means of “profiles,” “tiers,” and “levels,” namely, PTLs. A certain profile and its associated tiers and levels represent coding configurations that translate to different processing power requirements that a decoder has to satisfy when decoding the respective bitstreams. The VVC's PTLs are defined in annex A of the VVC specification (see Versatile Video Coding Editorial Refinements on Draft 10 (JVET-T2001), 20th Meeting, by teleconference, 7-16 Oct. 2020).

A “profile” is a subset of the entire bitstream syntax that is specified in VVC. Within the bounds defined by a given profile there is still a large variation in the performance of the encoder and the decoder that depends on the values used for syntax elements coded into the bitstream (such as the specified size of the decoded pictures). In many applications, it is currently neither practical nor economical to implement a decoder capable of dealing with all hypothetical values of syntax elements within a particular profile. In order to deal with this problem, “tiers” and “levels” are specified within each profile. Thus, a level of a tier is a specified set of constraints applied to values of the syntax elements coded into (or signaled in) the bitstream. Some of these constraints are expressed as simple limits on values, while others take the form of constraints on arithmetic combinations of values (e.g., picture width multiplied by picture height multiplied by the number of pictures decoded per second). Generally, a level specified for a lower tier is more constrained than a level specified for a higher tier.

A profile_tier_level( ) syntax structure provides level information and, optionally, profile, tier, sub-profile, and general constraint information to which one or more OLSs conform. The OLS that is associated with a givenprofile_tier_level( ) syntax structure is defined as the OLS in scope (i.e., OlsInScope). When the profile_tier_level( ) syntax structure is included in a VPS, the OlsInScope is one or more OLSs specified by the VPS. A list of PTLs is defined in the VPS, and for each OLS, an index is signaled that indicates which PTL the current OLS refers to. Thus, a given PTL can be associated with one or more OLSs. When the profile_tier_level( ) syntax structure is included in a sequence parameter set (SPS), the OlsInScope is the OLS that includes only the layer that is the lowest layer among the layers that refer to the SPS, and this lowest layer is an independent layer. In addition, a given level can be specified for a layer's sublayer, associated with a TemporalId value (applicable for temporal scalability use-cases).

The VVC standard also defines a network abstraction layer (NAL) unit, a decoded picture buffer (DPB), a picture unit (PU), and an access unit (AU). A NAL unit is a syntax structure containing an indication of the type of data to follow and bytes containing that data in the form of a raw byte sequence payload (RBSP) interspersed as necessary with emulation prevention bytes. A DPB is a buffer holding decoded pictures for reference, output reordering, or output delay specified for the hypothetical reference decoder (e.g., the reference picture buffers 280 and 380). A PU is a set of NAL units that are associated with each other according to a specified classification rule, are consecutive in decoding order, and contain exactly one coded picture. In other words, a PU represents the bitstream that is associated with one picture. As an example, a PU can contain several slices (in that case the PU contains consecutive Slice NAL units, and associated SPS, APS, SEIs NAL Units). An AU is a set of PUs that belong to different layers and that contains coded pictures to be outputted from the DPB at the same time. In other words, in a multilayer context, an AU represents the bitstream that is associated with a single picture represented by multiple layers. When there is only one layer, an AU contains only one picture.

For purposes of comparison of tiers' capabilities, the tier with general_tier_flag equal to 0 (i.e., the Main tier) is considered to be a lower tier than the tier with general_tier_flag equal to 1 (i.e., the Higher tier). For purposes of comparison of the capabilities of levels, a particular level of a specific tier is considered to be a lower level than some other level of the same tier when the value of the general_level_idc or sublayer_level_idc[i] of the particular level is less than that of the other level.

For an OLS with an OLS index TargetOlsIdx, the variables PicWidthMaxInSamplesY, PicHeightMaxInSamplesY, and PicSizeMaxInSamplesY, and the applicable dpb_parameters( ) syntax structure are derived as follows:

```
- If NumLayersInOls[TargetOlsIdx] is equal to 1,
  PicWidthMaxInSamplesY is set equal to sps_pic_width_max_in_luma_samples,
  PicHeightMaxInSamplesY is set equal to
  sps_pic_height_max_in_luma_samples, and PicSizeMaxInSamplesY is set equal
  to PicWidthMaxInSamplesY * PicHeightMaxInSamplesY, where
  sps_pic_width_max_in_luma_samples and
  sps_pic_height_max_in_luma_samples are found in the SPS referred to by the
  layer in the OLS, and the applicable dpb_parameters( ) syntax structure is also
  found in that SPS.
- Otherwise (NumLayersInOls[TargetOlsIdx] is greater than 1),
  PicWidthMaxInSamplesY is set equal to
  vps_ols_dpb_pic_width[ MultiLayerOlsIdx[TargetOlsIdx] ],
  PicHeightMaxInSamplesY is set equal to
  vps_ols_dpb_pic_height[ MultiLayerOlsIdx[TargetOlsIdx] ],
  PicSizeMaxInSamplesY is set equal to
  PicWidthMaxInSamplesY * PicHeightMaxInSamplesY, and the applicable
  dpb_parameters( ) syntax structure is identified by
  vps_ols_dpb_params_idx[ MultiLayerOlsIdx[ TargetOlsIdx ] ] found in the VPS.
```

Table 2 specifies the limits for each level of each tier for levels other than level 15.5 (i.e., Table 135 in the VVC standard). A tier and a level to which a bitstream conforms are indicated, respectively, by the syntax elements general_tier_flag and general_level_idc; and a level to which a sublayer representation conforms are indicated by the syntax element sublayer_level_idc[i], as follows:
If the specified level is not level 15.5, general_tier_flag equal to 0 indicates conformance to the Main tier, general_tier_flag equal to 1 indicates conformance to the High tier, according to the tier constraints specified in Table 2. And, general_tier_flag shall be equal to 0 for levels below level 4 (corresponding to the entries in Table 2 marked with “−”). Otherwise (the specified level is level 15.5), it is a requirement of bitstream conformance that general_tier_flag shall be equal to 1 and the value 0 for general_tier_flag is reserved for future use by ITU-T|ISO/IEC and decoders shall ignore that value of general_tier_flag.
general_level_idc and sublayer_level_idc[i] shall be set equal to a value of general_level_idc for the level number specified in Table 2.

TABLE 2
General tier and level limits

| | | | Max CPB size | | | | |
|---|---|---|---|---|---|---|---|
| | | | MaxCPB | | | | |
| | | Max luma | (CpbVclFactor or | | | | |
| | | picture | CpbNalFactor | | | | |
| | | size | bits) | | | Max # of | Max # of |
| | general_level_idc | MaxLumaPs | Main | High | Max slices per AU | tiles | tile columns |
| Level | value* | (samples) | tier | tier | MaxSlicesPerAu | MaxTilesPerAu | MaxTileCols |
| 1.0 | 16 | 36 864 | 350 | — | 16 | 1 | 1 |
| 2.0 | 32 | 122 880 | 1 500 | — | 16 | 1 | 1 |
| 2.1 | 35 | 245 760 | 3 000 | — | 20 | 1 | 1 |
| 3.0 | 48 | 552 960 | 6 000 | — | 30 | 4 | 2 |
| 3.1 | 51 | 983 040 | 10 000 | — | 40 | 9 | 3 |
| 4.0 | 64 | 2 228 224 | 12 000 | 30 000 | 75 | 25 | 5 |
| 4.1 | 67 | 2 228 224 | 20 000 | 50 000 | 75 | 25 | 5 |
| 5.0 | 80 | 8 912 896 | 25 000 | 100 000 | 200 | 110 | 10 |
| 5.1 | 83 | 8 912 896 | 40 000 | 160 000 | 200 | 110 | 10 |
| 5.2 | 86 | 8 912 896 | 60 000 | 240 000 | 200 | 110 | 10 |
| 6.0 | 96 | 35 651 584 | 80 000 | 240 000 | 600 | 440 | 20 |
| 6.1 | 99 | 35 651 584 | 120 000 | 480 000 | 600 | 440 | 20 |
| 6.2 | 102 | 35 651 584 | 180 000 | 800 000 | 600 | 440 | 20 |

*The level numbers in this table are in the form of “majorNum · minorNum,” and the value of general_level_idc for each of the levels is equal to majorNum * 16 + minorNum * 3.

Profile-specific level limits are described next. When the specified level is not level 15.5, the value of dpb_max_dec_pic_buffering_minus1[Htid]+1 shall be less than or equal to MaxDpbSize, which is derived as follows:

```
if ( 2 * PicSizeMaxInSamplesY <= MaxLumaPs )
  MaxDpbSize = 2 * maxDpbPicBuf
else if ( 3 * PicSizeMaxInSamplesY <= 2 * MaxLumaPs )
  MaxDpbSize = 3 * maxDpbPicBuf / 2
else
  MaxDpbSize = maxDpbPicBuf
```

where MaxLumaPs is specified in Table 2, maxDpbPicBuf is equal to 8, and dpb_max_dec_pic_buffering_minus1[Htid] is found in or derived from the applicable dpb_parameters( ) syntax structure. Assuming, numDecPics is the number of pictures in AU n, the variable AuSizeMaxInSamplesY[n] is set equal to PicSizeMaxInSamplesY*numDecPics.

Table 3 shows tier and level limits for the video profiles (i.e., Table 136 in the VVC standard). According to Table 3, limits for a given profile, level, and tier refer to all the layers of a given OLS. That is, if, for example, two layers have to be decoded, MaxLumaSr of one level would be doubled, compared to single level, to set the proper level to use.

TABLE 3
Tier and level limits for the video profiles

| | | Max bit rate MaxBR | | | |
|---|---|---|---|---|---|
| | Max luma | (BrVclFactor or | | Min compression | |
| | sample rate | BrNalFactor bits/s) | | ratio MinCrBase | |
| | MaxLumaSr | Main | High | Main | High |
| Level | (samples/sec) | tier | tier | tier | tier |
| 1.0 | 552 960 | 128 | — | 2 | 2 |
| 2.0 | 3 686 400 | 1 500 | — | 2 | 2 |
| 2.1 | 7 372 800 | 3 000 | — | 2 | 2 |
| 3.0 | 16 588 800 | 6 000 | — | 2 | 2 |
| 3.1 | 33 177 600 | 10 000 | — | 2 | 2 |
| 4.0 | 66 846 720 | 12 000 | 30 000 | 4 | 4 |
| 4.1 | 133 693 440 | 20 000 | 50 000 | 4 | 4 |
| 5.0 | 267 386 880 | 25 000 | 100 000 | 6 | 4 |
| 5.1 | 534 773 760 | 40 000 | 160 000 | 8 | 4 |
| 5.2 | 1 069 547 520 | 60 000 | 240 000 | 8 | 4 |
| 6.0 | 1 069 547 520 | 60 000 | 240 000 | 8 | 4 |
| 6.1 | 2 139 095 040 | 120 000 | 480 000 | 8 | 4 |
| 6.2 | 4 278 190 080 | 240 000 | 800 000 | 8 | 4 |

Following is an exemple for Multilayer Main 10 profile. Bitstreams conforming to the Multilayer Main 10 shall obey the following constraints:
Referenced SPSs shall have sps_chroma_format_idc equal to 0 or 1 (grey or 4:2:0 YUV video).
Referenced SPSs shall have sps_bitdepth_minus8 in the range of 0 to 2, inclusive (8 or 10 bits).
Referenced SPSs shall have sps_palette_enabled_flag equal to 0 (no palette tool is used).
In a bitstream conforming to the Multilayer Main 10 profile, general_level_idc and sublayer_level_idc[i] for all values of i in the referenced VPS (when available) and in the referenced SPSs shall not be equal to 255 (which indicates level 15.5).
The tier and level constraints specified for the Multilayer Main 10 profile, as applicable, shall be fulfilled.

Conformance of a bitstream to the Multilayer Main 10 profile is indicated by general_profile_idc being equal to 17.

Decoders conforming to the Multilayer Main 10 profile at a specific level of a specific tier shall be capable of decoding all bitstreams for which all of the following conditions apply:
The bitstream is indicated to conform to the Multilayer Main 10, Main 10, or Main 10 Still Picture profile.
The bitstream is indicated to conform to a tier that is lower than or equal to the specified tier.
The bitstream is indicated to conform to a level that is not level 15.5 and is lower than or equal to the specified level.

In addition to the PTL information, the PTL syntax structure may also include a general constraint information (GCI) syntax structure which contains a list of constraint flags and non-flag syntax elements that indicate specific constraint properties of the bitstream. GCI definition is part of the VVC standard. When present, a GCI syntax element value greater than 0 indicates that the bitstream is constrained in a particular way, typically to indicate that a particular coding tool is not used in the bitstream; whereas the value 0 signals that the associated constraint may not apply, such that the particular coding tool is allowed (but not required) to be used in the bitstream (if its use is supported in the indicated profile).

The GCI structure contains several types of constraint syntax elements, including:
Flags for general bitstream restrictions, such as flags indicating that only intra-coding is being used, that all layers are coded independently, or that the bitstream contains only one AU;
Fields constraining the bit depth and chroma format of the coded pictures;
Flags indicating that certain NAL unit types are not allowed to be present within the bitstream;
Flags constraining the ways that the pictures can be partitioned into slices, tiles, and subpictures within the bitstream;
Flags constraining the size of CTUs, as well as the size and type of partitioning trees;
Flags constraining the use of particular intra coding tools;
Flags constraining the use of particular inter coding tools;
Flags constraining the transform, quantization, and residual coding tools; and
Flags constraining aspects of in-loop filters.

A decoder conforming to the multilayer profile needs to be able to decode several layers for each frame. For each picture of a layer, the full toolset of the encoder can be used. Thus, the processing power required of the decoder can reach the sum of the processing power needed to decode each layer. There are no constraints defined by a PTL, or a profile/level, with constant max overall complexity for any number of layers, that can limit the processing power overhead of a decoder when decoding multiple layers (compared with decoding a single layer) while preserving the video's properties such as the picture resolution or frame rate.

Aspects of the present disclosure describe coding configurations for multilayer coding that result in reduced decoding complexity without compromising the compression performance. Generally, combinations of coding tools described herein are used in a more constrained manner for the coding of at least one of the layers of a multilayer video. A low complexity multilayer profile and a low latency multilayer profile are defined where bitstreams compliant with these profiles would be decodable with a decoder compliant to a single layer profile with only minor adaptations of the decoder.

As described above with reference to FIG. 4, the decoding of a current CU through the decoding pipeline 400 can be highly constrained by the coding tools' dependencies. These dependencies prevent a decoder implementation with high parallelism. Table 3 summarizes the coding tools' dependencies and their impact on the complexity of the decoding operation. Some tools are burdened by high dependencies 420 in the core of the decoding loop, such as the intra-prediction and LMCS tools. Other tools add latency (due to extra computations and memory accesses) to the CU decoding process, such as the BDOF and the DMVR tools. The LFNST tool adds an additional step to the inverse transform. The deblocking filter, the SAO, and the ALF tools do not add CU decoding dependencies but require additional computations for in-loop filtering after the CU is reconstructed 490 and before storing the reconstructed picture in the picture buffer for future reference. In a hardware decoder, these tools are designed to handle maximum resolution and frame rate in real-time with little margin. Handling multilayer video adds additional frames (of respective layers) to process.

TABLE 3
Decoder coding tools' dependency requirements.

| Function | Pipeline contraints | Effects |
|---|---|---|
| MC | Dependency on previously reconstructed | Basic codec building block |
| | pictures stored in the picture buffer | |
| Intra- | Dependency on neighboring | Prevents parallel CU |
| prediction | reconstructed CUs | reconstruction. |
| CC-based | Dependency on neighboring | Prevents parallel CU |
| Intra- | reconstructed CUs and reconstructed | reconstruction. |
| prediction | current luma components | |
| BCW | No additional constraint (merged to MC) | No significant additional latency |
| BDOF | Dependency on previously reconstructed | Additional latency |
| | pictures stored in the picture buffer and | |
| | on MC | |
| DMVR | Dependency on previously reconstructed | Additional latency |
| | pictures stored in the picture buffer and | |
| | on MC | |
| LFNST | Additional transform step | Additional latency |
| LMCS | Luma to chroma (cross-component) | Additional latency and prevents |
| | dependencies | parallel CU reconstruction. |
| Deblock | Dependency on reconstruction of all CUs | Additional latency |
| filter | | |
| SAO | Dependency on reconstruction of all CUs | Additional latency |
| ALF | Dependency on reconstruction of all CUs | Additional latency |

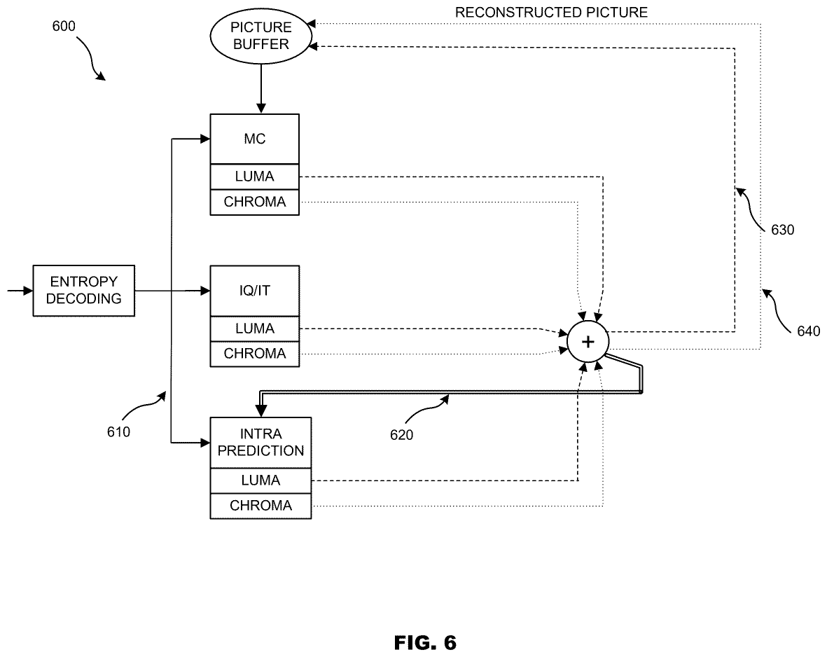

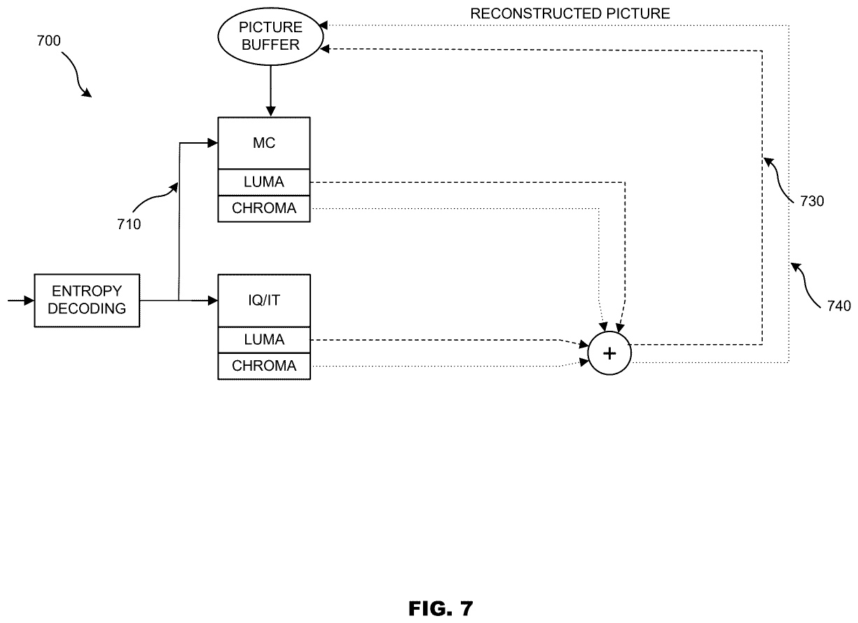

Aspects described herein are aimed at reducing the computation power required for decoding multiple layer bitstreams. This can be accomplished by both reducing the complexity of various stages of the decoding pipeline and reducing the number of decoding stages. FIG. 6 and FIG. 7 show examples of reducing dependency among CUs in the decoding pipeline. In each of these examples, a coding configuration is determined for which constraining coding tools have been deactivated, resulting in a more parallelizable and lower latency pipeline, as further described below.

FIG. 6 is a diagram illustrating a reduced CU decoding pipeline 600. In the example of FIG. 6, dependency on data flows that originated from the entropy decoder and the picture buffer is illustrated with full lines (e.g., 610), dependency on data flows associated with neighboring reconstructed CU(s) is illustrated with double lines (e.g., 620), dependency on data flows associated with the current luma component Y is illustrated with dashed lines (e.g., 630), and dependency on data flows associated with the current chroma component C is illustrated with dotted lines (e.g., 640). Relative to the CU decoding pipeline 400 presented in FIG. 4, in this decoding pipeline 600 the coding tools that increase the decoder's complexity have been deactivated. In this example for a reduced decoding pipeline 600, a coding configuration can be determined where some of the coding tools (e.g., BCW, BDOF, DMVR, LFNST, LMCS, deblock filtering, SAO, and ALF) are deactivated. Although the latency is reduced when using this decoding pipeline 600, the intra prediction tool requires the reconstruction of neighboring CUs 620 to predict the current CU. This dependency reduces the degree of parallelism that can be achieved in the decoding pipeline.

As mentioned above, the encoding of a layer (e.g., by layer encoder 530.1 of FIG. 5) may be based on a reference layer provided to it by the encoder that encodes the layer below (e.g., layer encoder 530.0 of FIG. 5). Similarly, the decoding of a layer (e.g., by layer decoder 580.1 of FIG. 5) may be based on a reference layer provided to it by the decoder that decodes the layer below (e.g., layer decoder 580.0 of FIG. 5). At both ends 510, 570 the provided reference layers (illustrated by the dashed arrows) can be used to predict CUs by respective layer encoders when inter-layer prediction is enabled. In this case, there is no need to employ the intra-prediction tool for all the layers that could possibly benefit from inter-layer prediction (e.g., layer encoders 530.1-N and layer decoders 580.1-N). Hence, a further reduction in decoding pipeline dependencies is possible when a coding configuration is determined for which intra-prediction tools (that highly impact the decoding pipeline) are deactivated, as described further with respect to FIG. 7.

FIG. 7. is a diagram illustrating a further reduced CU decoding pipeline 700. In the example of FIG. 7, dependency on data flows that originated from the entropy decoder and the picture buffer is illustrated with full lines (e.g., 710), dependency on data flows associated with the current luma component Y is illustrated with dashed lines (e.g., 730), and dependency on data flows associated with the current chroma component C is illustrated with dotted lines (e.g., 740). In this second example for a reduced CU decoding pipeline 700, a coding configuration can be determined for which constraining tools, including the intra prediction tool, are deactivated, resulting in a lower latency pipeline. However, in this case, deactivating the intra-prediction tool also allows for parallel decoding of the CUs of a layer (since dependency of a CU decoding on reconstruction of pixels from neighboring CUs is removed). For example, in this coding configuration, TM modes (where the reconstructed neighborhood of the current CU is used to predict coding parameters) can be disabled to avoid dependency on reconstruction of CUs above or to the left of the current CU.

Generally, and according to aspects described herein, to reduce latency and to increase decoding parallelism the coding configuration used for each layer can be accordingly determined. That is, the used coding toolset can be adapted for each layer. Using a layer-adapted coding toolset can reduce the overall processing power required of a decoder while maintaining the coding performance, in accordance with the requirements of an application of interest.

In a first aspect, the toolset that processes an enhancement layer can be reduced (and/or constrained). If the base layer must be encoded at high quality, the bandwidth allocated to the enhancement layer can be reduced. In this case, the base layer can be encoded based on a high-performance coding configuration, having all the tools (or a slightly reduced toolset) activated. On the other hand, there is no need to use a complex toolset to achieve high compression for the enhancement layer. In a spatial scalability use-case, for example, the base layer has lower resolution, which reduces the decoding complexity. Enhancement layers, however, can be coded with the reduced coding toolset, such as the one illustrated in FIG. 7. Additionally, because the base layer has a high quality, it can be used for interlayer prediction when, for example, inter-prediction fails at the refinement layer encoder. Such coding scheme can drastically reduce the processing power required of the decoder.

Using in-loop filters only for the base layer (or for one layer only), further reduces the latency and computational complexity. In a variant, the usage of in-loop filters is reduced in one or more layers. For example, the in-loop filters can be used for only some of the layers, not necessarily using all filters for a layer. Thus, deblocking filter and ALF can be used for the base layer, whereas only deblocking filter can be used for the enhancement layer(s); or, SAO and ALF can be used for the base layer and deblocking filter can be used for the enhancement layer(s). In this aspect, a decoding hardware component designed for decoding a single layer at a given resolution could be used for decoding a multilayer bitstream with small (software) adaptations. The core decoding loop will have enough power to decode both a base layer and a refinement layer because the former is at lower resolution and the latter is decoded with a reduced decoding pipeline with significantly lower complexity.

In a second aspect, the toolset that processes a base layer can be reduced. This is especially useful for applications where a low transmission delay is required, and hence the encoding and decoding must have very low latency. In addition to low bitrate constraints needed for fast transmission, complexity has a strong impact on both the encoder and the decoder. In this context, it may be advantageous to lower the encoding and decoding complexity of the base layer. Thus, in this aspect, constraints are applied to the coding of the base layer. The enhancement layer is used, for example, when a more powerful decoder is available or when the quality and/or resolution are more important than latency. In a low-delay multicast or broadcast application, some clients decode the base layer only. Other clients that can tolerate higher latency decode the base layer and one or more enhancement layers, and so can benefit from a higher resolution video. In that case, the base layer can be encoded with a reduced coding toolset, such as the one illustrated in FIG. 6. Intra-prediction can be used for the base layer to maintain sufficient compression performances. In-loop filters, however, can be selectively disabled to reduce the latency and the complexity. The enhancement layer, in this aspect, can use a high-performance coding configuration, for example, having most of the tools activated.

In a third aspect, a coding configuration for a layer may be determined so that the layer's group of pictures (GOP) can be modified—for example, the GOP's temporal depth and the GOP's length can be reduced. Generally, a longer GOP with a higher temporal depth 1) requires more and larger memory buffers to be allocated in the DPB for temporal prediction and 2) results in higher latency because the pictures are not coded in display order. Accordingly, a constrained layer may have a GOP that is shorter than other layers and/or a GOP with lower temporal depth, that is a lower maximum temporal ID (TID) value.

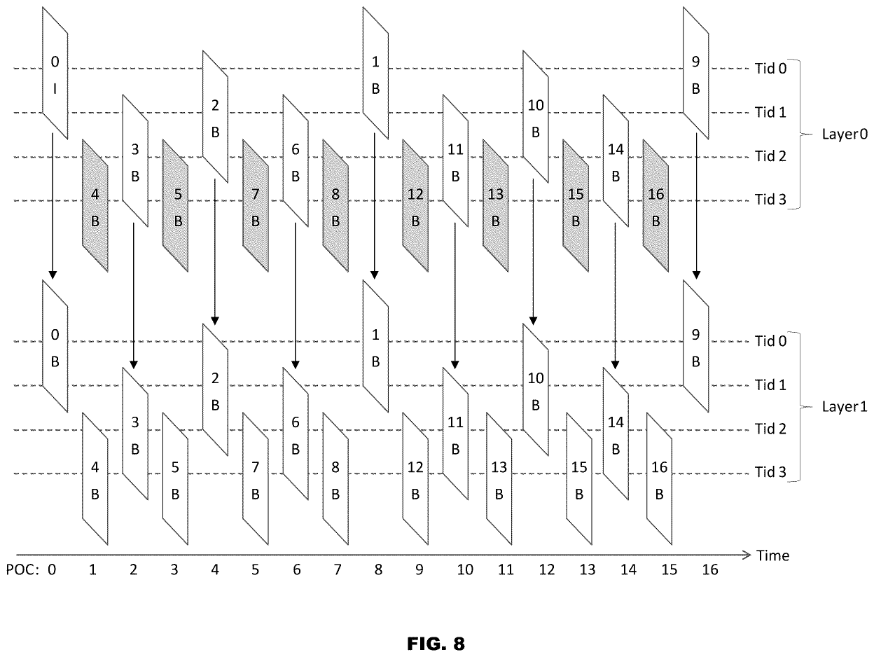

In a variant, a coding configuration for a layer may be determined so that inter-layer prediction may only be used for sublayers of the layer with a temporal ID value below a predetermined threshold (e.g., below the maximum temporal ID value). In VVC, a sublayer of a layer contains pictures of the layer that are at the same temporal depth. Thus, in this variant, for example, sublayers, of an enhancement layer, with higher TID values don't use inter-layer prediction. In such a case, the base layer can have the full frame-rate, whereas sublayers, of the base layer, with higher TID values are not used for inter-layer prediction for the enhancement layer (i.e., there is no decoding dependency with respect to the sublayers with the higher TID values, as illustrated in FIG. 8.

FIG. 8 is a diagram illustrating an inter-layer picture prediction 800. In the example of FIG. 8, pictures with higher TID values—that is, pictures with TID=3 (pictures 4, 5, 7, 8, 12, 13, 15, and 16, shown in grey in FIG. 8) of the base layer (layer 0)—are not used for inter-layer prediction for the refinement layer (layer 1). However, pictures with lower TID values—that is, pictures with TID=0-2 (Pictures 0, 3, 2, 6, 1, 11, 10, 14, and 9) of the base layer (layer 0)—are used for inter-layer picture prediction for the refinement layer (layer 1), as illustrated by the arrows. Thus, in the example of FIG. 8, only some (half) of the base-layer pictures need to be decoded in order to decode the enhancement layer (those picture with TID=0-2). Thus, requiring only some of the base layer's pictures to be decoded before the decoding of the corresponding pictures from the refinement layer reduces dependency and also reduces latency.

In a fourth aspect, a coding configuration for a layer may be determined so that the coding of residuals is constrained—that is, the use of residual data in reconstructing the coding units of the layer is limited. Constraining the coding of the residuals can decrease the decoder complexity. In this case, for example, CUs are reconstructed based on respective predicted CUs, without adding 255 to them reconstructed residual data (see FIG. 2). Thus, decoding CUs without reconstructing the respective residual data can significantly speed up the decoding process. In an aspect, constraining the residual coding may be implemented by setting to zero some of the transform coefficients (e.g., generated by the transformer 220 of FIG. 2) for one or more CUs.

In a fifth aspect, a coding configuration for a layer may be determined with respect to each sublayer of the layer so that a sublayer coding configuration can be determined based on the temporal ID value of the sublayer. Thus, constraints may be applied to the coding of a layer's picture based on the sublayer the picture is from. For example, constraints may be applied only to pictures of a layer that belong to a sublayer with the highest TID value. For example, in FIG. 8, four sublayers (of layer 0 and of layer 1) are illustrated that correspond to four temporal ID values. The VVC standard allows the decoding of only pictures (in a layer) with a TID value that is lower than or equal to a given value of TID. This capability provides for temporal scalability when a hierarchical GOP structure is used. One direct use of the temporal scalability feature is to scale down (e.g., skip the decoding of the pictures with the highest TID values) when sufficient processing power is not available. This approach resulting in a low frequency video that can cause saccades. An alternative approach, therefore, may be to constrain the tools used to code the pictures with the highest TID values so that they can be decoded with reduced processing power by using the restrictions described herein. Note that this aspect can be applied also for a single layer video (i.e., a classical broadcast scenario).

Hence, in this aspect, a coding configuration for a layer may be determined so that each sublayer of the layer is constrained differently, for example, by using a different toolset to encode each sublayer. Constraints on the encoding of sublayers can be applied in a binary manner, that is, a reduced toolset (or a constrained toolset) is applied when the TID value is above a threshold. Alternatively, or in combination, the toolsets can be applied progressively, that is, a further reduced (or a more constrained) toolset is applied as the TID value increases. For example, complex coding tools can be progressively and selectively disabled as the TID value of a picture increases. A list describing the complex tools can be predefined, or can be transmitted in the bitstream (e.g., in the VPS, SPS or the picture parameter set (PPS)).

Hence, pictures, of an enhancement layer, with the highest temporal ID values can be constrained. For example, decoding of residual data can be omitted when coding pictures, of the enhancement layer, with the highest temporal ID values. Thus, in this example, the CUS can be reconstructed based on respective predicted CUs. Alternatively, residual data may be used for the reconstruction of a limited number of CUs. This reduces the inverse transformer's 350 computational complexity. Constraining in this manner the coding and decoding of enhancement layer's pictures with the highest temporal ID is not likely to create perceptible artifacts.

Constraints on the coding of multilayer video and its layers' sublayers can be signaled in the bitstream to allow the decoder to check conformance. New multilayer profiles are described herein that contain constraints applied according to aspects described herein. A decoder that conforms to a given level of a tier of a profile is capable of decoding bitstreams that conform to the given level (and levels below) of the tier of that profile.

An example of a low complexity Multilayer Main 10 profile is described herein. Bitstreams conforming to this profile shall conform to the Multilayer Main 10 profile described above. In addition, bitstreams conforming to this profile shall satisfy the following constraints:

| Contraints | Description |
|---|---|
| In a NALU with multi-layer enabled (e.g., | Control of the in-loop filters: |
| nuh_layer_id greater than 0), the following | flags contained in the SPS referred to by the |
| flags are set to zero: sps_lmcs_enabled_flag, | corresponding layer's NALU |
| sps_sao_enabled_flag, and | sps_lmcs_enabled_flag = 0: disable LMCS |
| sps_alf_enabled_flag. | sps_sao_enabled_flag = 0: disable SAO |
| And, pps_deblocking_filter_disabled_flag is | sps_alf_enabled_flag = 0: disable ALF |
| set to 1. | flags contained in the PPS referred to by the |
| | corresponding layer's NALU |
| | pps_deblocking_filter_disabled_flag = 1: |
| | disable deblocking filter |
| In a NALU with nuh_layer_id greater than 0, | Control of coding tools: |
| the following flags are set to zero: | flags contained in the SPS referred to by the |
| sps_lfnst_enabled_flag, | corresponding layer's NALU |
| sps_bcw_enabled_flag, | sps_lfnst_enabled_flag = 0: disable LFNST |
| sps_bdof_enabled_flag, | sps_bcw_enabled_flag = 0: disable BCW |
| sps_ciip_enabled_flag, and | sps_bdof_enabled_flag = 0: disable BDOF |
| sps_dmvr_enabled_flag. | sps_ciip_enabled_flag = 0: disable CIIP |
| | sps_dmvr_enabled_flag = 0: disable DMVR |
| In a NALU with nuh_layer_id greater than 0, | In slice header syntax, syntax element |
| in slice header syntax, sh_slice_type shall not | sh_slice_type = {0, 1} (i.e., only P or B slices). |
| be equal to 2 (I Slice) (i.e., only P or B slices). | |
| In a NALU with nuh_layer_id greater than 0, | In slice data syntax, per CU syntax element |
| in slice data syntax, pred_mode_flag shall be | pred_mode_flag = 0 (only INTER prediction) |
| equal to zero. | |
| If NumLayersInOls[TargetOlsIdx] is greater | inter_layer_ref_pic_flag = 0: no inter-layer |
| than 1, | reference picture for temporalID greater than a |
| reference pictures of pictures with | threshold (e.g., 3) |
| nuh_layer_id greater than 0 and temporalID | |
| greater than 3 shall have its | |
| inter_layer_ref_pic_flag (inter-layer reference | |
| picture flag) false. | |

Conformance of a bitstream to the low complexity Multilayer Main 10 profile is indicated by general_profile_idc being equal to 19 (or another new number).

An example of a low latency Multilayer Main 10 profile is described herein. Bitstreams conforming to this profile shall conform to the Multilayer Main 10 profile described above. In addition, bitstreams conforming to this profile shall satisfy the following constraints:

| Contraints | Description |
|---|---|
| In a NALU with nuh_layer_id equal to 0, the | Control of the in-loop filters: |
| following flags are set to zero: | flags contained in the SPS referred to by the |
| sps_lmcs_enabled_flag, | corresponding layer's NALU |
| sps_sao_enabled_flag, | sps_lmcs_enabled_flag = 0: disable LMCS |
| sps_alf_enabled_flag. | sps_sao_enabled_flag = 0: disable SAO |
| And, pps_deblocking_filter_disabled_flag is | sps_alf_enabled_flag = 0: disable ALF |
| set to 1 | flags contained in the PPS referred to by the |
| | corresponding layer's NALU |
| | pps_deblocking_filter_disabled_flag = 1: |
| | disable deblocking filter |
| In a NALU with nuh_layer_id equal to 0, the | Control of coding tools: |
| following flags are set to zero: | flags contained in the SPS referred to by the |
| sps_lfnst_enabled_flag, | corresponding layer's NALU |
| sps_bcw_enabled_flag, | sps_lfnst_enabled_flag = 0: disable LFNST |
| sps_bdof_enabled_flag, | sps_bcw_enabled_flag = 0: disable BCW |
| sps_ciip_enabled_flag, and | sps_bdof_enabled_flag = 0: disable BDOF |
| sps_dmvr_enabled_flag. | sps_ciip_enabled_flag = 0: disable CIIP |
| | sps_dmvr_enabled_flag = 0: disable DMVR |

Conformance of a bitstream to the low latency Multilayer Main 10 profile is indicated by general_profile_idc being equal to 21 (or another new number).

GCI syntax can also be used. To apply constraints to a layer, the constraints can be integrated into GCI syntax element that is contained in the profile_tier_level structure defined in an SPS that the specific layer is referring to.

The constraints include, for example, setting existing flags to one: gci_no_cclm_constraint_flag, gci_no_bdof_constraint_flag, gci_no_dmvr_constraint_flag, gci_no_prof_constraint_flag, gci_no_bcw_constraint_flag, gci_no_ciip_constraint_flag, gci_no_lfnst_constraint_flag, gci_no_sao_constraint_flag, gci_no_alf_constraint_flag, and gci_no_Imcs_constraint_flag. As well as setting to one new flags that are added to the GCI structure: gci_inter_only_constraint_flag and gci_no_deblock_constraint_flag.

FIG. 9 is a flowchart of an example method 900 for encoding a multilayer video, according to which aspects of the present embodiments can be implemented. The method 900 begins, in step 910, by obtaining video data, including multilayer video. In step 920, coding configurations are determined to adapt to respective layers of the multilayer video. Then, in step 930, the layers of the multilayer video are coded into a bitstream based on their respective coding configurations. In an aspect, the method 900 can be applied to 1) determine a coding configuration for a first layer of the multilayer video, where inter-layer prediction is activated to enable the generation of a reference layer during the coding of the first layer; and 2) determine a coding configuration for a second layer of the multilayer video, where usage of the reference layer during the coding of the second layer is enabled. Thus, coding dependency among coding units of the second layer can be eliminated by using inter-layer prediction to predict the coding units. Accordingly, when coding the second layer, coding of a coding unit of the second layer is not dependent on reconstruction of pixels from neighboring coding units. Advantageously, in this aspect, decoding of the coding units of the second layer can be implemented in parallel.

In another aspect, the method 900 can be applied to 1) determine a coding configuration for a first layer of the multilayer video, defining a first toolset for coding the first layer; and 2) determine a coding configuration for a second layer of the multilayer video, defining a second toolset for coding the second layer. Where, one of the first and second toolsets is a reduced toolset relative to the other one of the first and second toolsets. In an aspect, the first layer can be a base layer and the second layer can be a refinement layer. For example, a toolset can be reduced by deactivating one or more in-loop filters, or by deactivating the coding of residual data for one or more coding units of a respective layer. In another example, method 900 can be applied to constrain the coding configuration of a layer (e.g., relative to the coding configurations of the other layers in the multilayer video) by reducing a temporal depth of a GOP of the layer or by reducing a length of the GOP of the layer.

A layer of the multilayer video can contain sublayers associated with respective temporal ID values. In this case, method 900 can be further applied to determine a coding configuration for the layer, including sublayer coding configurations that are determined based on the respective temporal ID values of the sublayers. In an aspect, determining of the sublayer coding configurations may include determining a first toolset for a first sublayer and a second toolset for a second sublayer, where the temporal ID value of the second sublayer is higher than the temporal ID value of the first layer, and where the second toolset is reduced relative to the first toolset. In a further aspect, method 900 can be applied to constrain the coding configuration of a layer (e.g., relative to the coding configurations of the other layers of the multilayer video) by using inter-layer prediction only for sublayers of the layer with temporal ID values below a predetermined threshold (as described with respect to FIG. 8). In yet another aspect, method 900 can be applied to constrain the coding configuration of a layer (e.g., relative to the coding configurations of the other layers of the multilayer video) by limiting the use of residual data in reconstructing coding units for sublayers of the layer with temporal ID values below a predetermined threshold.

Method 900 can be further configured to signal (i.e., code into the bitstream) one or more syntax elements that represent a layer's coding configuration (of the coding configurations determined in step 920 for respective layers). The signaled syntax elements can represent a profile, a tier, and a level that define the coding configuration for the layer, as demonstrated above by the examples for the low complexity Multilayer Main 10 profile and the low latency Multilayer Main 10 profile. In the case where the layer includes sublayers, the profile, tier, and level can further define the coding configuration for each sublayer (i.e., sublayer coding configurations).

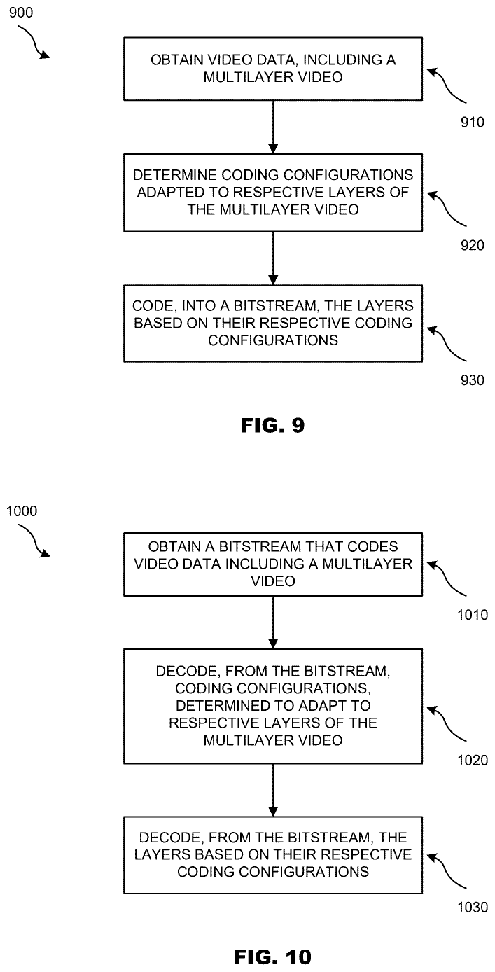

FIG. 10 is a flowchart of an example method 1000 for decoding a multilayer video, according to which aspects of the present embodiments can be implemented. This decoding method 1000 generally reverses the operation of the encoding method 900 described above. The method 1000 begins, in step 1010, by obtaining a bitstream that codes video data including a multilayer video. In step 1020, the method 1000 can be applied to decode from the bitstream coding configurations, determined (in step 920 of method 900) to adapt to respective layers of the multilayer video. Then, in step 1030, the method 1000 can be applied to decode from the bitstream the layers based on their respective coding configurations. The decoding (in step 1020) of a layer's coding configuration can include decoding one or more syntax elements (signaled in the bitstream) that represent the coding configuration. The signaled syntax elements represent a profile, a tier, and a level that define the coding configuration, as demonstrated above by the examples for the low complexity Multilayer Main 10 profile and the low latency Multilayer Main 10 profile. In the case where the layer includes sublayers, the profile, tier, and level can further define the coding configuration for each of the sublayer (i.e., sublayer coding configurations).

We have described several aspects and embodiments in the present disclosure. These aspects and embodiments provide at least the following outputs and results, including all combinations, across different claim categories and types:
Encoding, into coded video data, syntax elements that can enable the decoder to decode the coded video data, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, or a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.
   Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to a specific standard (such as VVC or HEVC) and can be applied, for example, to other standards and recommendations, as well as extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream. Additionally, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including, for example, manners that are common in video standards such as putting the information into an SPS, a PPS, a NAL unit, a header (for example, a NAL unit header, or a slice header), or an SEI message. Other manners are also available, including, for example, manners common for system level or application level standards such as signaling the information into one or more of the following:
a. SDP (session description protocol), a format for describing multimedia communication sessions for the purposes of session announcement and session invitation, for example, as described in RFCs and used in conjunction with RTP (Real-time Transport Protocol) transmission.
b. DASH MPD (Media Presentation Description) Descriptors, for example, as used in DASH and transmitted over HTTP. A descriptor is associated with a Representation or collection of Representations to provide additional characteristics to the content Representation.
c. RTP header extensions, for example, as used during RTP streaming.
d. ISO Base Media File Format, for example, as used in OMAF and using boxes which are object-oriented building blocks defined by a unique type identifier and length (also known as ‘atoms’ in some specifications).
e. HLS (HTTP live Streaming) manifest transmitted over HTTP. A manifest can be associated, for example, with a version or collection of versions of content to provide the characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (PDAs), and other devices that facilitate communication of information between end-users.

Reference to “one/an aspect” or “one/an embodiment” or “one/an implementation,” as well as other variations thereof, means that a particular feature, structure, characteristic, and so forth described in connection with the aspect/embodiment/implementation is included in at least one embodiment. Thus, the appearances of the phrase “in one/an aspect” or “in one/an embodiment” or “in one/an implementation,” as well any other variations, appearing in various places throughout this application, are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization parameter for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual data, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method comprising:
obtaining video data, including a multilayer video;
determining, for each layer of the multilayer video, a coding configuration, defined in a profile, a tier, and a level of the layer;
coding, into a bitstream, the layers based on their respective coding configurations; and
coding, into the bitstream, the profile, the tier, and the level of each layer.

2. The method according to claim 1, wherein the layers include a first layer and a second layer, and wherein the determining of the coding configurations comprises:
determining a coding configuration for the first layer, wherein inter-layer prediction is activated to enable generation of a reference layer during the coding of the first layer; and
determining a coding configuration for the second layer, wherein usage of the reference layer during the coding of the second layer is enabled.

3. The method according to claim 2, the coding of the layers further comprises:
coding the second layer, wherein coding of a coding unit of the second layer is not dependent on reconstruction of pixels from neighboring coding units.

4. The method according to claim 1, wherein the layers include a first layer and a second layer, and wherein the determining of the coding configurations comprises:
determining a coding configuration for the first layer, defining a first toolset for coding the first layer; and
determining a coding configuration for the second layer, defining a second toolset for coding the second layer,
wherein one of the first and second toolsets is a reduced toolset relative to the other one of the first and second toolsets.

5. The method according to claim 4, wherein the first layer is a base layer and the second layer is a refinement layer.

6. The method according to claim 4, wherein in the reduced toolset one or more in-loop filters are deactivated.

7. The method according to claim 4, wherein in the reduced toolset, coding of residual data, for one or more of coding units of a respective layer, is deactivated.

8. The method according to claim 1, further comprising:
constraining a coding configuration of a layer of the multilayer video, relative to the coding configurations of other layers of the multilayer video, by reducing a temporal depth of a group of pictures (GOP) of the layer.

9. The method according to claim 1, further comprising:
constraining a coding configuration of a layer of the multilayer video, relative to the coding configurations of other layers of the multilayer video, by reducing a length of a GOP of the layer.

10. The method according to claim 1, wherein a layer of the multilayer video contains sublayers associated with respective temporal ID values and wherein the determining of the coding configurations comprises:
determining respective sublayer coding configurations for the sublayers of the layer based on the respective temporal ID values of the sublayers.

11. The method according to claim 10, wherein the determining of the sublayer coding configurations further comprises:
determining a first toolset for a first sublayer and a second toolset for a second sublayer, wherein a temporal ID value of the second sublayer is higher than a temporal ID value of the first sublayer, and wherein the second toolset is reduced relative to the first toolset.

12. The method according to claim 1, wherein a layer of the multilayer video contains sublayers associated with respective temporal ID values and wherein the determining of the coding configurations comprises:
constraining a coding configuration of the layer by using inter-layer prediction only for sublayers of the layer with temporal ID values below a predetermined threshold.

13. The method according to claim 1, wherein a layer of the multilayer video contains sublayers associated with respective temporal ID values and wherein the determining of the coding configurations comprises:
constraining a coding configuration of the layer by limiting the use of residual data in reconstructing coding units for sublayers of the layer with temporal ID values below a predetermined threshold.

14. A method comprising:
obtaining a bitstream, coding video data including a multilayer video;
decoding, from the bitstream, for each layer of the multilayer video, a profile, a tier, and a level, defining a respective coding configuration; and
decoding, from the bitstream, the layers based on their respective coding configurations.

15. The method according to claim 14, wherein a layer of the multilayer video contains sublayers associated with respective temporal ID values and wherein the coding configurations comprises sublayer coding configurations determined for the sublayers of the layer based on the respective temporal ID values of the sublayers.

16. (canceled)

17. The method according to claim 1614, wherein the coding configuration includes a sublayer coding configuration, and wherein the profile, the tier, and the level further define the sublayer coding configuration.

18. An apparatus, comprising:
at least one processor; and
memory storing instructions that, when executed by the at least one processor, cause the apparatus to:
obtain video data, including a multilayer video,
determine, for each layer of the multilayer video, a coding configuration, defined in a profile, a tier, and a level of the layer,
code, into a bitstream, the layers based on their respective coding configurations, and
code, into the bitstream, the profile, the tier, and the level of each layer.

19. The apparatus according to claim 17, wherein the layers include a first layer and a second layer, and wherein the determining of the coding configurations comprises:
determining a coding configuration for the first layer, wherein inter-layer prediction is activated to enable generation of a reference layer during the coding of the first layer; and
determining a coding configuration for the second layer, wherein usage of the reference layer during the coding of the second layer is enabled.

20. The apparatus according to claim 17, wherein the layers include a first layer and a second layer, and wherein the determining of the coding configurations comprises:
determining a coding configuration for the first layer, defining a first toolset for coding the first layer; and
determining a coding configuration for the second layer, defining a second toolset for coding the second layer,
wherein one of the first and second toolsets is a reduced toolset relative to the other one of the first and second toolsets.

21. An apparatus, comprising:
at least one processor; and
memory storing instructions that, when executed by the at least one processor, cause the apparatus to:
obtain a bitstream, coding video data including a multilayer video,
decode, from the bitstream, for each layer of the multilayer video, a profile, a tier, and a level, defining a respective coding configuration, and
decode, from the bitstream, the layers based on their respective coding configurations.

22-26. (canceled)
